(19) United States
(12) Patent Application Publication
(10) Pub. No.: US 2026/0195568 A1
(43) Pub. Date: Jul. 9, 2026

(54) INFORMATION PROCESSING APPARATUS, INFORMATION PROCESSING METHOD, AND COMPUTER READABLE MEDIUM

(71) Applicant: NEC Corporation, Minato-ku, Tokyo (JP)

(72) Inventor: Darshit VAGHANI, Tokyo (JP)

(73) Assignee: NEC Corporation, Minato-ku, Tokyo (JP)

(21) Appl. No.: 18/034,823

(22) PCT Filed: Nov. 13, 2020
(86) PCT No.: PCT/JP2020/042509

§ 371 Date: May 1, 2023

(51) Int. Cl. G06N 3/0464

(52) U.S. Cl. CPC G06N 3/0464

(57) ABSTRACT

An object of the present disclosure is to provide an information processing apparatus capable of reducing redundant computation in ACNN. An information processing apparatus includes at least one memory configured to store instructions; and at least one processor configured to execute the instructions to: generate label information, while the label information indicates which convolutional block(s) in an artificial convolutional neural network (ACNN) model should be used for calculation of training the ACNN model, the ACNN model including a plurality of convolutional blocks; and train a policy neural network (NN) model by the label information, while the policy NN model is used for determining which convolutional block(s) in the ACNN model should be used for calculation.

### TECHNICAL FIELD

The present disclosure relates to an information processing apparatus, an information processing method, and a non-transitory computer readable medium.

### BACKGROUND ART

In the modern era, the artificial convolutional neural network (ACNN) has become the state-of-the-art solutions for several vision processing applications like classification, object detection, semantic segmentation, and so forth.

As a related art of this technology, Patent Literature 1 (PTL 1) discloses a reinforcement learning system. This reinforcement learning system has an action selection policy neural network and trains the action selection policy neural network using a reinforcement learning technique. Owing to the training, the reinforcement learning system can generate policy outputs that maximize the expected long-term time-discounted reward.

### CITATION LIST

### Patent Literature

PTL 1: WO 2018/053187

### SUMMARY OF INVENTION

### Technical Problem

To reach high accuracy of output, ACNN is often required to include many convolutional blocks comprising convolutional layers. Consequently, the calculation amount of ACNN tends to be excessive, however, PTL 1 does not disclose this problem.

An object of the present disclosure is to provide an information processing apparatus, an information processing method, and a non-transitory computer readable medium capable of reducing redundant computation in ACNN.

### Solution to Problem

In a first example aspect, an information processing apparatus includes: an artificial convolutional neural network (ACNN) training means for training an ACNN model by input data, while the ACNN model includes a plurality of convolutional blocks; a label generating means for generating label information, while the label information indicates which convolutional block(s) in the ACNN model should be used for calculation of the input data; and a policy neural network (NN) training means for training a Policy NN model by the label information, while the Policy NN model is used for determining which convolutional block(s) in the ACNN model should be used for calculation.

In a second example aspect, an information processing method includes: training an artificial convolutional neural network (ACNN) model by input data, while the ACNN model includes a plurality of convolutional blocks; generating label information, while the label information indicates which convolutional block(s) in the ACNN model should be used for calculation of the input data; and training a policy neural network (NN) model by the label information, while the Policy NN model is used for determining which convolutional block(s) in the ACNN model should be used for calculation.

In a third example aspect, a non-transitory computer readable medium storing a program to causes a computer to execute: training an artificial convolutional neural network (ACNN) model by input data, while the ACNN model includes a plurality of convolutional blocks; generating label information, while the label information indicates which convolutional block(s) in the ACNN model should be used for calculation of the input data; and training a policy neural network (NN) model by the label information, while the Policy NN model is used for determining which convolutional block(s) in the ACNN model should be used for calculation.

According to the present disclosure, it is possible to provide an information processing apparatus, an information processing method, and a non-transitory computer readable medium capable of reducing redundant computation in ACNN.

### BRIEF DESCRIPTION OF DRAWINGS

FIG. 1 is a block diagram of a model training system according to a related art.

FIG. 2 is a block diagram illustrating an ACNN model according to the related art.

FIG. 3 is a block diagram of an information processing apparatus according to a first example embodiment.

FIG. 4 is a flowchart illustrating a method of the information processing apparatus according to the first example embodiment.

FIG. 5 is a block diagram of a model training system according to a second example embodiment.

FIG. 6 is a block diagram illustrating an ACNN model according to the second example embodiment.

FIG. 7 is a flowchart illustrating a method of the model training system according to the second example embodiment.

FIG. 8 is a table illustrating outputs of convolutional blocks for sample example Image 1 according to the second example embodiment.

FIG. 9 is a table illustrating outputs of convolutional blocks for sample example Image 2 according to the second example embodiment.

FIG. 10 is a schematic diagram illustrating selection of the convolutional blocks for example Image 1 according to the second example embodiment.

FIG. 11 is a schematic diagram illustrating selection of the convolutional blocks for example Image 2 according to the second example embodiment.

FIG. 12 is a table illustrating contents of a Block Vitality database.

FIG. 13 is a block diagram of an information processing apparatus according to embodiments.

### DESCRIPTION OF EMBODIMENTS

### Outline of Related Art

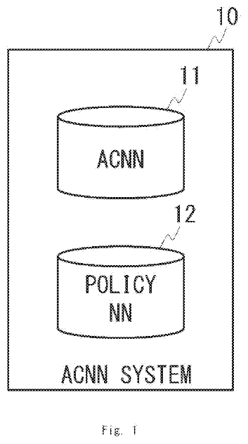

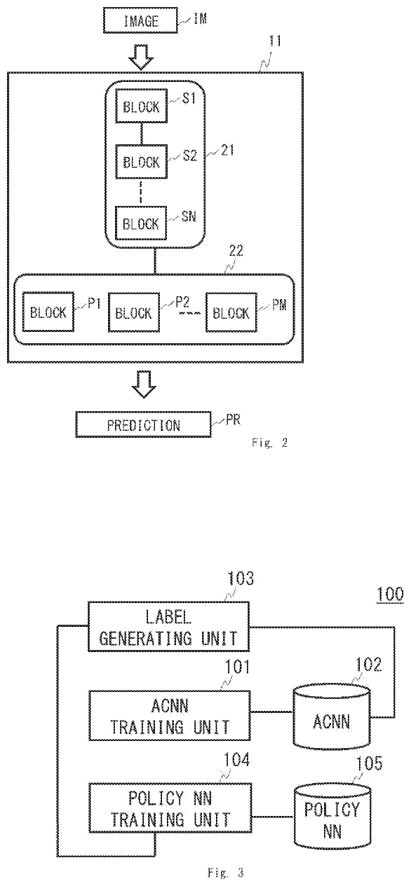

Prior to explaining embodiments according to this present disclosure, an outline of related art is explained with reference to FIGS. 1 and 2.

ACNN is usually trained by using training database that primarily consists of several training images and corresponding target labels. The training images are input to ACNN and after several calculations, ACNN generates the prediction. The prediction can be class, bounding box, segmentation, height, weight, and so forth of the object in the image or about the image. The generation of the prediction for the input image by ACNN is commonly referred to as forward propagation of ACNN. The prediction is compared with the target label and based on how far the prediction is from the target label, the parameters (weights) of ACNN are updated. The updating of the parameters of the ACNN is commonly referred to as backpropagation. Several interleaved executions of forward propagation and backpropagation are commonly referred to as the training phases. Also, only the forward propagation of the ACNN for an input image is commonly referred to as an inference phase.

After the training phase, the test image is input to the trained ACNN in the inference phase, and ACNN generates a prediction. The primary reason for the wide acceptance of the ACNN is high accuracy in the predictions in the inference phase.

In FIG. 1, an ACNN system (model training system) 10 is illustrated. The ACNN system comprise an ACNN model 11 (hereinafter referred to as the ACNN 11) and a policy neural network model 12 (hereinafter referred to as the Policy NN 12).

A sample example of the ACNN 11 is shown in FIG. 2. After the training phase, an Image IM is input to the trained ACNN 11 and the trained ACNN 11 outputs prediction PR. The ACNN 11 comprises of several convolutional blocks (In FIG. 2, they are noted as “Block”). Each convolutional block comprises of several convolution layers performing operations like deconvolution, convolution, up sampling, Rectified Linear Unit (ReLU), and others. The arrangement of the convolutional blocks plays crucial part in the accuracy of trained ACNN 11. The convolutional blocks are either arranged in cascade or parallel or both as shown in FIG. 2.

In FIG. 2, the convolutional blocks arranged in cascade are shown as a cascade block unit 21. In the case of a cascaded arrangement, a convolutional block (represented as a Block S1, Block S2, . . . , Block SN in FIG. 2) gets input from one or a plurality of preceding blocks (e.g. many preceding blocks) in the ACNN 11. Thus, in the cascade block unit 21, the convolutional blocks get executed sequentially.

In FIG. 2, the convolutional blocks arranged in parallel are shown as a parallel block unit 22. In the case of a parallel arrangement, multiple convolutional blocks (represented as Block P1, Block P2, . . . , Block PM in FIG. 2) are arranged in parallel style such that execution of all the convolutional block are independent of each other. In other words, none of the convolutional blocks have input from other parallel-arranged convolutional blocks.

Generally, parallel-arranged convolutional blocks are designed to extract different variations of the feature. One of the examples but not limited to is a shape feature of the object. Different possible shape variation of the object in the image is extracted by different parallel convolutional blocks. From the output of parallel-arranged convolutional block, one or a plurality of output(s) is/are selected for later convolutional blocks in ACNN 11. The outputs corresponding to non-selected ones are ignored.

The ACNN 11 with high accuracy capability generally have large numbers of cascade and parallel convolutional blocks and thereby demanding large computations. The requirement of large computations makes the ACNN 11 troublesome to be employed in computationally resource-limited systems.

To reduce computations complexity of the ACNN 11, partial execution of the ACNN 11 is one of the candidate solutions. Since an input image does not always have complex objects or variety of objects, some part of computation in the ACNN is not always contributing to the accuracy of the prediction. Therefore, by omitting certain computations, the ACNN 11 has the acumen to maintain high accuracy.

“BlockDrop: Dynamic Inference Paths in Residual Networks” written by Wu et al., published in 2018 at CVPR 2018 (hereinafter referred to as improved related art) introduces the concept of using the Policy NN for partial execution of ACNN. In FIG. 1, the Policy NN 12 is introduced for this reason.

Basically, the Policy NN 12 is employed to determine/guide the ACNN 11 to perform computations of only vital convolutional blocks for an input image(s).

The Policy NN 12 generates the guidance in terms of a policy/scheme for the ACNN 11. The prediction of the Policy NN 12 is referred as policy. The policy indicates which all convolutional blocks in the ACNN 11 need to be kept or dropped for a given input image while preserving the accuracy. Then the ACNN 11 will compute only the convolutional blocks that were to be kept as per the policy during the inference. Of course, computational overhead introduces by hired Policy NN 12 should be smaller than the ACNN 11.

However, in the improved related art, there is a disadvantage of additional training time required for the Policy NN 12. In the improved related art, reinforcement learning based on the training of Policy NN 12 is used. In the reinforcement learning, due to no fixed good policy to reduce the computations, while preserving the accuracy, it tends to explore large search space. Such large space exploration making long training time inevitable for the improved related art. Consequently, there are two major problems.

A first problem is a difficulty in exploring the large search space for a good Policy NN that not only reduces the computation but also preserves the accuracy of the ACNN 11.

The reason for the first problem is the number of policies to be explored for the ACNN 11 with N convolutional blocks is 2N for input images. Also, there exists a tradeoff between reduced computation and accuracy. Intuitively, omitting some computations in the ACNN 11 will hamper the accuracy. In the worst case, the product of 2N and the number of training images are the number of policies to be explored for the training of good Policy NN 12.

A second problem is a limitation of requiring certain preparation after the training phase of the ACNN 11, which introduces a delay in the commencement of the training phase of Policy NN 12.

A reason for the above limitation is the requirement of obtaining training information from the training phase of the ACNN 11 and then performing certain extra computations using some extra computations module.

The present disclosure relates to building a good Policy NN to accelerate ACNN computation with less degradation in the accuracy. In other words, the principal objective of the present disclosure is to provide a time-efficient training method, which can perform partial execution for an input image with less accuracy degradation.

### First Example Embodiment

First, an information processing apparatus 100 according to a first example embodiment of the present disclosure is explained with reference to FIG. 3.

Referring to FIG. 3, the information processing apparatus 100 includes an artificial convolutional neural network (ACNN) training unit 101, an ACNN model 102 (hereinafter referred to as the ACNN 102), a label generating unit 103, a Policy NN training unit 104 and a Policy NN model (hereinafter referred to as the Policy NN 105). The information processing apparatus 100 is, for example, a computer or a machine. As an example, at least one of components in the information processing apparatus 100 can be installed in the information processing apparatus 100 as a combination of one or a plurality of memories and one or a plurality of processors.

The ACNN training unit 101 trains the ACNN 102 by input data. The input data may be stored in the information processing apparatus 100, however, the input data may be input to the ACNN training unit 101 from outside the information processing apparatus 100.

The ACNN 102 includes a plurality of convolutional blocks. These convolutional blocks may be arranged in cascade or parallel. The ACNN 102 is trained by the ACNN training unit 101 with the input data and can output prediction. Examples of the prediction are already shown before.

The label generating unit 103 generates label information. The label information indicates which a convolutional block or convolutional blocks (hereinafter referred to as convolutional block(s)) in the ACNN 102 should be used for calculation of the input data. For example, the label information may indicate which the convolutional block(s) arranged in parallel should be used for the calculation. As an example, the label generating unit 103 can generate this label information based on calculation of the training of ACNN 102 done by the ACNN training unit 101.

The Policy NN training unit 104 trains the Policy NN 105 by the label information generated by the label generating unit 103. The Policy NN 105 is used for determining which convolutional block(s) in the ACNN 102 should be used for calculation for general-purpose. Therefore, as the Policy NN 105 is trained well, the computation in the ACNN 102 for general-purpose can be reduced more without losing the accuracy of the output of the ACNN 102.

Next, referring to the flowchart in FIG. 4, an example of the operation of the present example embodiment will be described.

First, the ACNN training unit 101 trains the ACNN by the input data (step S11 in FIG. 4). The input data includes, for example, image data. However, it is not limited to this example.

Next, the label generating unit 103 generates the label information (step S12 in FIG. 4). As shown before, the label generating unit 103 may generate this label information based on the calculation in the training phase of the ACNN 102.

Finally, the Policy NN training unit 104 trains the Policy NN 105 by the label information generated by the label generating unit 103 (step S13 in FIG. 4). By doing these processes, the information processing apparatus 100 can reduce redundant computation in the ACNN 102 by using the trained Policy NN 105.

Furthermore, this method can suppress deterioration of the accuracy of the ACNN 102, because the training of the Policy NN 105 may be based on the actual calculation result of the training of the ACNN 102.

In this example embodiment, the information processing apparatus 100 includes the ACNN 102 and the Policy NN 105. However, at least one of the ACNN 102 and the Policy NN 105 may be located outside the information processing apparatus 100.

### Second Example Embodiment

Next, a second example embodiment of this disclosure will be described below referring to the accompanying drawings. This second example embodiment shows one of the specific examples of the first example embodiment, however, specific examples of the first example embodiment are not limited to this.

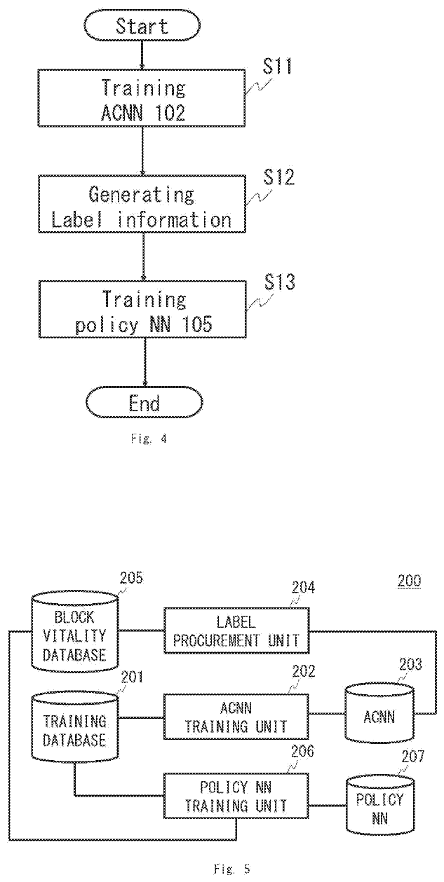

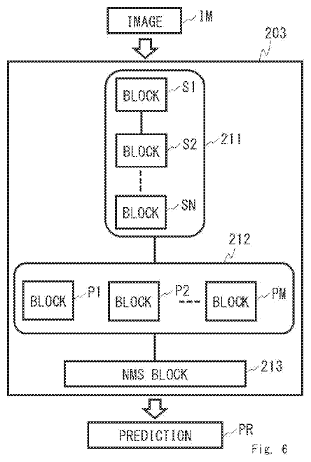

FIG. 5 shows a model training system according to a second example embodiment. As shown in FIG. 5, the model training system 200 includes a training database 201, an ACNN training unit 202, an ACNN model 203 (hereinafter referred to as the ACNN 203), a Label procurement unit 204, a Block Vitality database 205, a Policy NN training unit 206 and a Policy NN model 207 (hereinafter referred to as the Policy NN 207). The model training system 200 can be realized as a system installed in an information processing apparatus P. The model training system 200 may include other units for computation. In this example embodiment, the model training system 200 can be applied to the image recognition, however, the application is not limited to this.

The training database 201 is a database comprising of images along with corresponding label(s) of each image. The label is the target of the prediction, which the model training system 200 seeks to procure as an output of the ACNN 203 after the training phase.

The ACNN training unit 202 comprises of capabilities of getting images along with the labels from the training database 201, performing training and validation of the ACNN 203 in the training phase of the ACNN 203. Furthermore, in the inference phase of the ACNN 203, the ACNN training unit 202 can get the images from the training database 201 and infer all images on the ACNN 203.

The ACNN 203 is the neural network model that receives input signals in the form of an image, executes several convolutional blocks, and generates prediction. As shown above, the ACNN training unit 202 trains the ACNN 203. After the ACNN 203 undergoes the training phase, it is referred here as a trained ACNN 203. The trained ACNN is inferred for all images in the training database 201 by the ACNN training unit 202. The model training system 200 uses the training database 201 and the ACNN training unit 202 to produce the trained ACNN in this way.

FIG. 6 shows the configuration of the ACNN 203. The ACNN 203 includes a cascade block unit 211, a parallel block unit 212 and a Non-Maximum Suppression (NMS) block. The details of each block are shown below.

The cascade block unit 211 includes a plurality of convolutional blocks arranged in cascade. In the case of a cascaded arrangement, the convolutional block (represented as a Block S1, Block S2, . . . , Block SN in FIG. 6) gets input from one or a plurality of preceding blocks (e.g. many preceding blocks) in the ACNN 203. Thus, in the cascade block unit 211, the convolutional blocks get executed sequentially.

The parallel block unit 212 includes a plurality of convolutional blocks arranged in parallel. In the case of a parallel arrangement, multiple convolutional blocks (represented as a Block P1, Block P2, . . . , Block PM in FIG. 6) are arranged in parallel style such that execution of all the convolutional block are independent of each other. In other words, in the parallel block unit 212, none of the convolutional blocks have input from other parallel-arranged convolutional blocks.

Each of convolutional blocks in the cascade block unit 211 and in the parallel block unit 212 comprises of several convolution layers performing operations like deconvolution, convolution, up sampling, Rectified Linear Unit (ReLU), and others. The arrangement of the convolutional blocks plays crucial part in the accuracy of the trained ACNN 203.

The NMS block 213 is the final block of the computation in the ACNN 203. This block performs operations such as Non-Maximum Suppression (NMS). The output of the NMS block 213 is the prediction of the trained ACNN 203.

Contrary to the sequentially executed cascade-arranged convolutional blocks in the cascade block unit 211, the parallel-arranged convolutional blocks in the parallel block unit 212 get executed independently. Once all the parallel-arranged convolutional blocks in the parallel block unit 212 are executed, the outputs are supplied forward to subsequent convolutional block, if any. If the parallel-arranged convolutional blocks are at the tail/deeper part of the ACNN 203 (i.e. no subsequent convolutional block exists), then the outputs are supplied forward to the final block, i.e. the NMS block 213. After the training phase, an Image IM is input to the trained ACNN 203 and the trained ACNN 203 outputs prediction PR.

Referring back to FIG. 5, the Label procurement unit 204 procures the information that output(s) of which one or a plurality of the parallel-arranged convolutional block(s) in the parallel block unit 212 got selected for the respective input image by the NMS block 213. The procured label information by the Label procurement unit 204 is used for generating the Block vitality database 205.

The Block vitality database 205 comprises of labels which represent each of the parallel convolutional blocks of the parallel block unit 212 in the trained ACNN 203. Each label has a binary value, i.e. “keep” or “drop”. The “keep” value is assigned to the label, if the output of corresponding representing parallel convolutional block was selected during the inference of the respective images by the NMS block 213. The parallel convolutional blocks whose outputs were not selected by the NMS block 213 are assigned “drop” value.

The “keep” value indicates that the particular parallel convolutional block represented by the label is vital, and hence the trained ACNN 203 should be guided by the Policy NN 207 to execute the particular parallel convolutional block for the respective input image. In other words, the “keep” label signifies that the corresponding parallel convolutional block in the parallel block unit 212 is proficient to extract the feature present in the object of the particular input image.

Similarly, the “drop” value indicates that the particular parallel convolutional block represented by the label is insignificant and hence the trained ACNN 203 should be guided by the Policy NN 207 to omit the execution of the particular parallel convolutional block for the respective input image. In other words, the “drop” value indicates that the corresponding parallel convolutional block in the parallel block unit 212 is not proficient to extract a particular feature in the object of the input image.

Hence, it can be derived that the “keep” and “drop” values for the parallel convolutional block represent the fixed policy/scheme that should be guided for a particular input image to the trained ACNN 203.

The Policy NN training unit 206 obtains images from the training database 201 and corresponding labels from the Block vitality database 205, performs training and validation of the Policy NN 207 in the training phase of the Policy NN 207. As a result, the trained Policy NN 207 is generated. Further, in the inference phase of the Policy NN 207, the Policy NN training unit 206 can get the images from the training database 201 and infer all images on the Policy NN 207.

The Policy NN 207 is the neural network model that receives the input signals in the form of an image, executes several computations, and generates policy. The policy is basically a several binary outputs. Each binary output corresponds to “keep” or “drop” the execution of the respective parallel-arranged convolutional blocks in the trained ACNN 203. Hence the number of binary outputs of the Policy NN 207 is at least equal to the number of the parallel-arranged convolutional blocks in the trained ACNN 203. After the Policy NN 207 undergoes the training phase, it is referred here as a trained Policy NN 207.

The model training system 200 uses the Block vitality database 205 (i.e. the labels of the Block vitality database 205) and the Policy NN training unit 206 to produce the trained Policy NN 207 in this way.

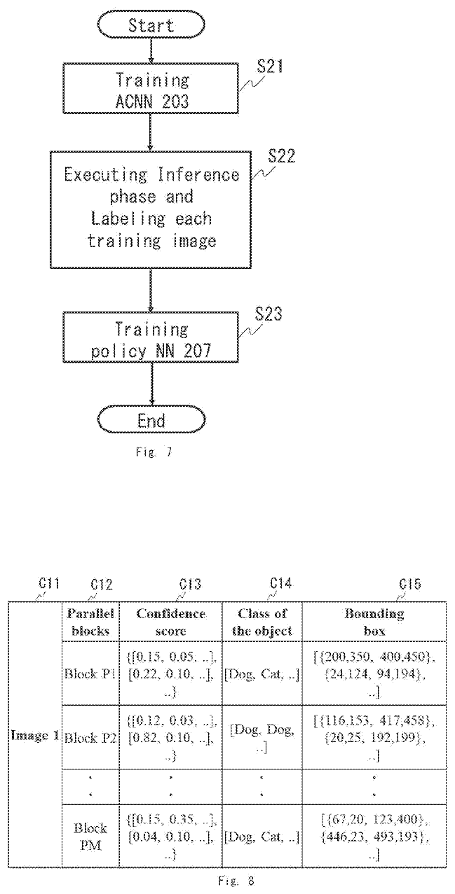

Referring to the flowchart in FIG. 7, an example of the operation of the present example embodiment will be described.

First, the model training system 200 uses the training database 201 and the ACNN training unit 202 to produce the trained ACNN 203. Specifically, in the training phase of the ACNN 203, the ACNN training unit 202 obtains images along with the labels from the training database 201 and trains the ACNN 203 to generate the trained ACNN 203 (step S21 in FIG. 7).

Next, after the training phase of the ACNN 203, the model training system 200 uses the ACNN training unit 202 in the inference phase for the trained ACNN 203 (step S22 in FIG. 7). In the inference phase of the trained ACNN 203, the trained ACNN 203 infers all the images in the training database 201. During the inference, i.e. during the forward propagation of each image, all the convolutional blocks of the trained ACNN 203 get executed.

During the inference, contrary to the cascade-arranged convolutional blocks in the cascade block unit 211, the parallel-arranged convolutional blocks in the parallel block unit 212 get executed independently. The NMS block 213 outputs the prediction of the trained ACNN 203 based on the result of the NMS.

The outputs of all parallel convolutional blocks in the same trained ACNN 203 may differ from one input image to another. One example of the outputs would be in the object detection task, wherein all the parallel convolutional blocks predict the bounding boxes with each having a confidence score for multiple classes.

However, they are not limited to this example. For the case with an input image containing a small object of a particular class, different parallel convolutional blocks would have different confidence scores and bounding boxes as compared to the other case with an input image containing a larger object or different class.

FIGS. 8 and 9 respectively shows tabular representation of the sample example of the outputs of the parallel convolutional blocks for an input Image 1 and input Image 2. The column C11 in FIG. 8 and column C21 in FIG. 9 respectively represent the name of Images, i.e. Image 1 and Image 2. The column C12 in FIG. 8 and column C22 in FIG. 9 respectively represent the parallel blocks, i.e. Block Pl to PM. The column C13 in the FIG. 8 and column C23 in FIG. 9 respectively represent the lists of arrays of confidence score for the multiple class. The sequence of elements in each array in the column C13 and C23 corresponds to the sequence of the class of the object being predicted. The column C14 in FIG. 8 and column C24 in FIG. 9 respectively represent the sequence of class. In this embodiment, examples of the class of the object are “dog” and “cat”. The column C15 in FIG. 8 and column C25 in FIG. 9 represent the lists of bounding boxes predicted by the respective parallel convolutional block.

The outputs of the parallel convolutional blocks in the parallel block unit 212 having the confidence scores above a predefined threshold score are selected by the NMS block 213 in FIG. 6 as its output.

For the sample training examples in FIGS. 8 and 9, consider the predefined threshold score is 0.5. Then from all the outputs of the parallel convolutional blocks for input Image 1, the NMS block 213 selects the output of Block P2. The reason of the selecting is, in FIG. 8, only Block P2 has a confidence score, 0.82, namely over 0.5.

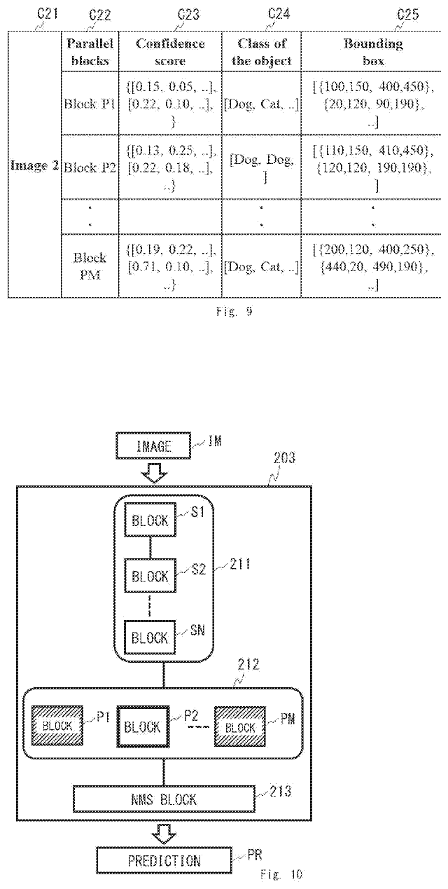

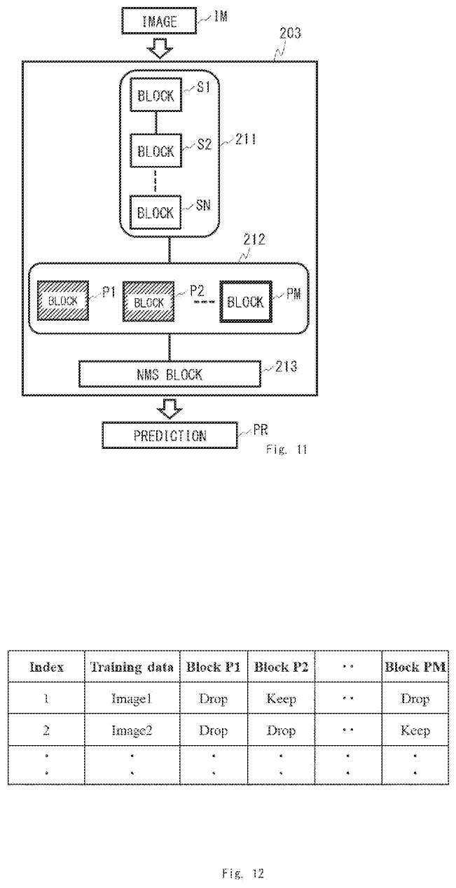

FIG. 10 shows the situation regarding FIG. 8. In FIG. 10, Block P2, which is selected by the NMS block 213, is shown as a white block bordered with the bold edge. However, other Blocks in the parallel block unit 212, which are not selected by the NMS block 213, are shown as hatched blocks.

Similarly, from all the outputs of the parallel convolutional blocks for input Image 2, the NMS block 213 selects the output of Block PM. The reason of the selecting is, in FIG. 9, only Block PM has a confidence score, 0.71, namely over 0.5.

FIG. 11 shows the situation regarding FIG. 9. In FIG. 11, Block PM, which is selected by the NMS block 213, is shown as a white block bordered with the bold edge. However, other Blocks in the parallel block unit 212, which are not selected by the NMS block 213, are shown as hatched blocks.

As mentioned above, the information that output(s) of which one or a plurality of the parallel convolutional block(s) got selected for the respective input image by the NMS block 213 is procured by the Label procurement unit 204. The Label procurement unit 204 uses the information to generate the Block vitality database 205. The Block vitality database 205 includes the information of “keep” and “drop” values for the parallel convolutional block in the parallel block unit 212. In this way, keep/drop labels are generated from the inference phase of the trained ACNN 203 for all images in the training database 201, and these keep/drop labels along with their respective images in the training database can be used for the training Policy NN 207 by the Policy NN training unit 206 to obtain good Policy NN model. This process is called as “Labeling each training image” of step S22 in FIG. 7.

Once all the images in the training database 201 is inferred on the trained ACNN 203, then at the end of step S22 in FIG. 7, a new database termed as the Block vitality database 205 is obtained.

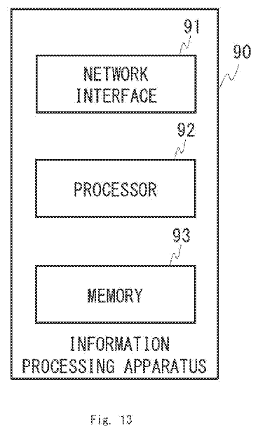

FIG. 12 shows tabular representation of the sample example of the label information in the Block vitality database 205. As explained above, regarding Image 1, the Block P2 is selected by the NMS block 213, therefore, it is assigned a “keep” value in FIG. 12. In contrast, other Blocks in the parallel block unit 212 are not selected by the NMS block 213, therefore, they are assigned “drop” values in FIG. 12.

Similarly, regarding Image 2, the Block PM is selected by the NMS block 213, therefore, it is assigned a “keep” value in FIG. 12. In contrast, other Blocks in the parallel block unit 212 are not selected by the NMS block 213, therefore, they are assigned “drop” values in FIG. 12.

The Policy NN training unit 206 comprises of the capabilities of getting images along with the labels from Block vitality database 205, performing the training and validation of the Policy NN 207.

As shown above, the policy generated by the Policy NN 207 is basically a several binary outputs. Each binary output corresponds to “keep” or “drop” the execution of the respective parallel-arranged convolutional blocks in the trained ACNN 203.

In the training phase of the Policy NN 207, the Policy NN training unit 206 trains the Policy NN 207 to generate the trained Policy NN 207 (step S23 in FIG. 7). To that end, the Policy NN training unit 206 uses the label information in the Block vitality database 205.

It should be noted that for each input image, a fix policy which exists for the Policy NN 207 can be learnt. Therefore, the exploration of large search space for good Policy NN 207 is not required.

Also, no extra computation or computation means required by the model training system 200. Just after obtaining the trained ACNN 203, shorter time is required for label procurement on all images in the training database 201 by executing the inference phase once on the trained ACNN 203, and the commencement of training of the Policy NN 207 can be done immediately. Therefore, it is possible to provide a time-efficient training method, which can perform partial execution for an input image.

Another key point of the model training system 200 is the execution corresponding to the convolutional blocks whose outputs would not be selected are guided to be omitted by the Policy NN 207. Hence, it can be concluded with the assurance that there would be less accuracy degradation in the prediction by the trained ACNN 203.

In this example embodiment, the convolutional blocks in the parallel block unit 212 (i.e. the Block P1, P2, . . . , PM) are selection objects for the Policy NN 207.

Therefore, the model training system 200 can reduce excessive computation by unnecessary parallel-arranged convolutional block(s) in the ACNN 203.

In this example embodiment, the ACNN 203 is used for image recognition and the image IM is input to the ACNN 203 as the input data for the calculation. Therefore, the model training system 200 can reduce redundant computation in the field of the image recognition.

Further, the convolutional blocks in the parallel block unit 212 are selection objects for the Policy NN 207 and different convolutional blocks extract different variations of the feature (specifically possible shape variation) of an object in the image. Therefore, the model training system 200 can specify the exact shape of the object in the image with less time.

In this example embodiment, the NMS block and the label procurement unit 204 (corresponding to the label generating unit 103) generates the label information during the inference phase of the ACNN 203. Therefore, as there is no need to prepare new data for generating the label information, the model training system 200 can reduce the time for the training of the Policy NN 207.

In this example embodiment, the label procurement unit 204 generates the label information based on the function of NMS. Therefore, the model training system 200 can detect objects with less time.

Furthermore, the label information is generated based on the confidence scores of each convolutional block. Therefore, the object detection can be done with high accuracy by the model training system 200.

It should be noted that in the description of this disclosure, elements represented by the singular forms “a”, “an” and “the” may be not only single elements but also multiple elements, unless the context explicitly stated otherwise.

It should be noted that the present invention is not limited to the above-described embodiment, and may be modified as appropriate without departing from the spirit of the invention. For example, the object for the computation is not limited to images.

In the second example embodiment, at least one of the training database 201, the ACNN 203, the Block Vitality database 205 and the Policy NN model 207 may be located outside the information processing apparatus P.

Next, a configuration example of the information processing apparatus explained in the above-described plurality of embodiments is explained hereinafter with reference to FIG. 13.

FIG. 13 is a block diagram showing a configuration example of the information processing apparatus. As shown in FIG. 13, the information processing apparatus 90 includes a network interface 91, a processor 92 and a memory 93.

The network interface 91 is used for communication with other network node apparatuses forming a communication system. For example, the network interface 91 may receive data stored in the training database 201 and/or the Block Vitality database 205.

The processor 92 performs processes explained with reference to the drawings in the above-described embodiments by loading software (a computer program) from the memory 93 and executing the loaded software. The processor 92 may be, for example, a microprocessor, an MPU (Micro Processing Unit), or a CPU (Central Processing Unit). The processor 92 may include a plurality of processors. In this case, each of the processors executes one or a plurality of programs including a group of instructions to cause a computer to perform an algorithm explained above with reference to the drawings.

The memory 93 may be formed by a volatile memory or a nonvolatile memory, however, the memory 93 may be formed by a combination of a volatile memory and a nonvolatile memory. The memory 93 may include a storage disposed apart from the processor 92. In this case, the processor 92 may access the memory 93 through an I/O interface (not shown).

In the example shown in FIG. 13, the memory 93 is used to store a group of software modules. The processor 92 can perform processes explained in the above-described embodiments by reading the group of software modules from the memory 93 and executing the read software modules.

As explained above, each of the configurations in the above-described embodiments may be constituted by the combination of hardware and software (a computer program). However, it may be constituted by one hardware or software, or may be constituted by a plurality of hardware or software.

In the above-described examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Note that the present disclosure is not limited to the above-described embodiments and can be modified as appropriate without departing from the spirit and scope of the present disclosure.

### REFERENCE SIGNS LIST

100 INFORMATION PROCESSING APPARATUS
101 ACNN TRAINING UNIT
102 ACNN MODEL
103 LABEL GENERATING UNIT
104 POLICY NN TRAINING UNIT
105 POLICY NN MODEL
200 MODEL TRAINING SYSTEM
201 TRAINING DATABASE
202 ACNN TRAINING UNIT
203 ACNN MODEL
204 LABEL PROCUREMENT UNIT
205 BLOCK VITALITY DATABASE
206 POLICY NN TRAINING UNIT
207 POLICY NN MODEL
211 CASCADE BLOCK UNIT
212 PARALLEL BLOCK UNIT
213 NMS BLOCK

What is claimed is:

1. An information processing apparatus comprising:
at least one memory configured to store instructions; and
at least one processor configured to execute the instructions to:
generate label information, while the label information indicates which convolutional block(s) in an artificial convolutional neural network (ACNN) model should be used for calculation of training the ACNN model, the ACNN model including a plurality of convolutional blocks; and
train a policy neural network (NN) model by the label information, while the policy NN model is used for determining which convolutional block(s) in the ACNN model should be used for calculation.

2. The information processing apparatus according to claim 1, wherein the convolutional blocks in the ACNN model are arranged in parallel.

3. The information processing apparatus according to claim 1, wherein the ACNN model is used for image recognition and an image is input to the ACNN model, while the image is input data to the ACNN model for the calculation.

4. The information processing apparatus according to claim 3, wherein the convolutional blocks in the ACNN model are arranged in parallel, and different convolutional blocks in the ACNN model extract different possible feature variation of an object in the image.

5. The information processing apparatus according to claim 1,
wherein the at least one processor is further configured to generate the label information during an inference phase of the ACNN model by using input data to the ACNN model for the calculation.

6. The information processing apparatus according to claim 1,
wherein the at least one processor is further configured to generate the label information based on a function of Non-Maximum Suppression (NMS).

7. The information processing apparatus according to claim 6, wherein the label information is also based on confidence scores of each convolutional block in the ACNN model.

8. An information processing method performed by a computer comprising:
generating label information, while the label information indicates which convolutional block(s) in an artificial convolutional neural network (ACNN) model should be used for calculation of training the ACNN model, the ACNN model including a plurality of convolutional blocks; and
training a policy neural network (NN) model by the label information, while the policy NN model is used for determining which convolutional block(s) in the ACNN model should be used for calculation.

9. A non-transitory computer readable medium storing a program for causing a computer to execute:
generating label information, while the label information indicates which convolutional block(s) in an artificial convolutional neural network (ACNN) model should be used for calculation of training the ACNN model, the ACNN model including a plurality of convolutional blocks; and
training a policy neural network (NN) model by the label information, while the policy NN model is used for determining which convolutional block(s) in the ACNN model should be used for calculation.

10. The information processing apparatus according to claim 1, wherein the at least one processor is further configured to train the ACNN model.
